(19) United States
(12) Patent Application Publication
(10) Pub. No.: US 2012/0209883 A1
(43) Pub. Date: Aug. 16, 2012

(54) CONTENT ITEM SEARCH APPARATUS AND METHOD

(75) Inventors: Hideki TSUTSUI, Kawasaki-shi (JP); Masaru SUZUKI, Kawasaki-shi (JP); Toshihiko MANABE, Kamakura-shi (JP)

(73) Assignee: KABUSHIKI KAISHA TOSHIBA, TOKYO (JP)

(21) Appl. No.: 13/421,501

(22) Filed: Mar. 15, 2012

Related U.S. Application Data
(63) Continuation of application No. PCT/JP2009/066102, filed on Sep. 15, 2009.

(51) Int. Cl. G06F 17/30

(52) U.S. Cl. 707/779; 707/E17.014

(57) ABSTRACT

According to one embodiment, a content item search apparatus includes an extraction unit, a storage and a presentation unit. The extraction unit extracts one or more elements corresponding to a search word from one or more content items for each of classes, based on extraction rules indicating expressions to extract the elements indicating character strings required to specify relationships between the search word and the classes. The storage stores, as expression information, the extracted elements and the search word. The presentation unit generates one or more explanatory expressions associated with the search word based on generation rules and the expression information, and presents the explanatory expressions.

### CROSS REFERENCE TO RELATED APPLICATIONS

This application is a Continuation Application of PCT Application No. PCT/JP2009/066102, filed Sep. 15, 2009, the entire contents of which are incorporated herein by reference.

### FIELD

Embodiments described herein relate generally to a content item search apparatus and method.

### BACKGROUND

Upon searching for television programs, video content items on a network, and the like, a method of searching for a target content item by inputting search words such as a title, broadcast date, performer, and keyword of a video content item, and executing matching with metadata of content items is normally adopted. In this case, since a user load upon inputting search words is heavy, a system which presents searchable search words and allows the user to select the presented search words, so as to search for a content item, is available as a search word input support technique (See, e.g., JP-A. No. 2007-300497(KOKAI)).

### BRIEF DESCRIPTION OF THE DRAWINGS

FIG. 1 is a block diagram illustrating a content item search apparatus according to an embodiment.

FIG. 2 is a view illustrating EPG data items stored in a program information storage.

FIG. 3 is a flowchart illustrating the operation of an explanatory expression extraction unit.

FIG. 4 is a table illustrating an example of explanatory expression class determination rules.

FIG. 5 is a table illustrating an example of explanatory expression extraction rules.

FIG. 6 is a table illustrating an example of explanatory expression information items stored in an explanatory expression storage.

FIG. 7 is a view illustrating an example of a presentation method of a search word presentation unit.

FIG. 8 is a view illustrating an example of a presentation method of the search word presentation unit and an explanatory expression presentation unit.

FIG. 9 is a table illustrating an example of explanatory expression generation rules.

### DETAILED DESCRIPTION

However, when the system presents search words including those the user should know but he or she has forgotten, the user cannot recognize the substances of the search words, and it is difficult to select the search word.

In general, according to one embodiment, a content item search apparatus includes an extraction unit, a first storage and a presentation unit. The extraction unit is configured to extract at least one of elements from at least one of content items for each of classes, based on extraction rules indicating expressions used to extract the elements which indicate character strings required to specify relationships between a search word and the classes in the content items, the elements corresponding to the search word in association with each other, the classes each indicating either one of a role and a category, the role and the category being those of the search word in each of the content items. The first storage stores expression information items, the expression information items each comprising one of the extracted elements and the search word, the search word being stored for each class. The presentation unit is configured to generate one or more explanatory expressions associated with the search word based on generation rules and the expression information items and present the one or more explanatory expression for each search word, the generation rules each indicating a template used to generate the explanatory expressions which indicate explanatory texts of the search word.

A content item search apparatus and method according to an embodiment will be described in detail hereinafter with reference to the drawings. Note that in the following embodiment, parts denoted by the same reference numbers perform the same operations, and a repetitive description thereof will be avoided.

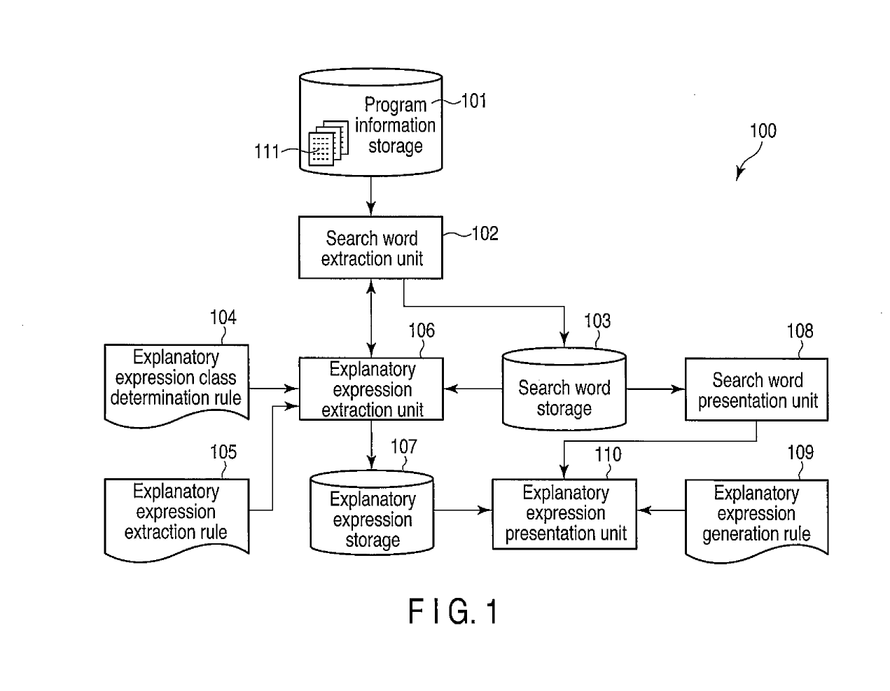

A content item search apparatus according to this embodiment will be described in detail below with reference to FIG. 1.

The content item search apparatus according to this embodiment is used when the user searches for a video content item appended with metadata. As the video content item, television programs, and video content items on a network can be used. As the appended metadata, an electronic program guide (EPG) can be used for television programs, titles and explanatory text of video contents, message boards associated with the video contents, and the like can be used for video contents on a network. The following description will be given while taking television programs as an example of the video contents, and EPG data items as that of the appended metadata.

A content item search apparatus 100 according to this embodiment includes a program information storage 101, search word extraction unit 102, search word storage 103, explanatory expression extraction unit 106, explanatory expression storage 107, search word presentation unit 108, and explanatory expression presentation unit 110.

The program information storage 101 stores EPG data items in advance. As the EPG data items to be stored, all of previously delivered EPG data items may be stored, or only EPG data items of programs which have been viewed and recorded by the user may be stored, and those of programs which have not been viewed or recorded by the user may be discarded.

Whether or not the user has viewed each program can be determined as follows. For example, in history information 111 indicating whether or not the user has viewed or recorded a program, a history flag is set when the user viewed the program, and the above determination can be made with reference to this history flag.

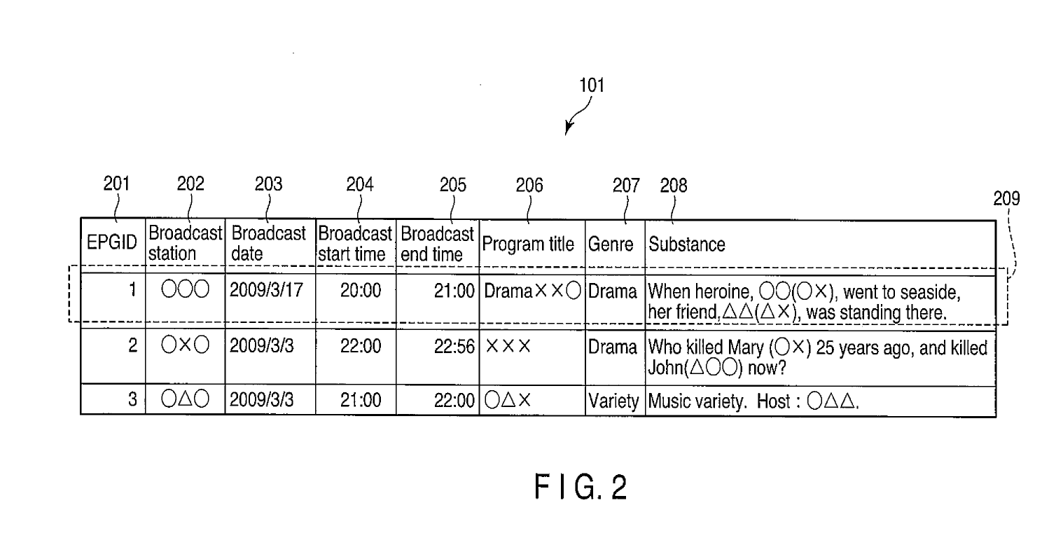

An example of EPG information stored in the program information storage 101 will be described in detail below with reference to FIG. 2.

As EPG information, items of an EPGID 201, broadcast station 202, broadcast date 203, broadcast start time 204, broadcast end time 205, program title 206, genre 207, and substance 208 are saved as program information item 209 in the program information storage 101 in association with each other. For example, as for a program having an EPGID 201=“1”, program information item 209 indicating a “[drama] which was broadcast by a broadcast station [OOO] during a time zone from [20:00] to [21:00] on [2009/3/17], and has a title [drama xxO] and a substance [when heroine, OO (Ox), went to seaside, her friend, ΔΔ (Δx), was standing there]”, can be obtained.

The search word extraction unit 102 extracts search words and EPGIDs including the search words from the EPG data items stored in the program information storage 101. The search words are personal names indicating a performer, player, athlete, and the like, and are used to search for a television program. As a method of extracting personal names from the EPG data items, a state-of-the-art technique can be used. For example, a method of applying morphological analysis to the EPG data items so as to extract proper nouns or names can be used.

The search word storage 103 receives the search words extracted by the search word extraction unit 102, and stores the received search words and EPGIDs of program information items included in the EPG data items from which the search words are extracted in association with each other. For example, a personal name is extracted as a search word from EPG data items, and the personal name and an EPGID of program information items from which this personal name is extracted are stored as a pair. Note that in order to search for many television programs, search words may be acquired from not only EPG data items including items of currently or previously broadcast program information items but also those including items of program information items scheduled to be broadcast in the future. For example, personal names may be extracted from EPG data items including a broadcast schedule a week ahead, and the personal names and EPGIDs of items of program information items as extraction sources of these personal names may be stored in association with each other. Note that not only an EPGID of a program as an extraction source of a search word but also the search word and program information items itself as the extraction source of the search word may be stored in the search word storage 103.

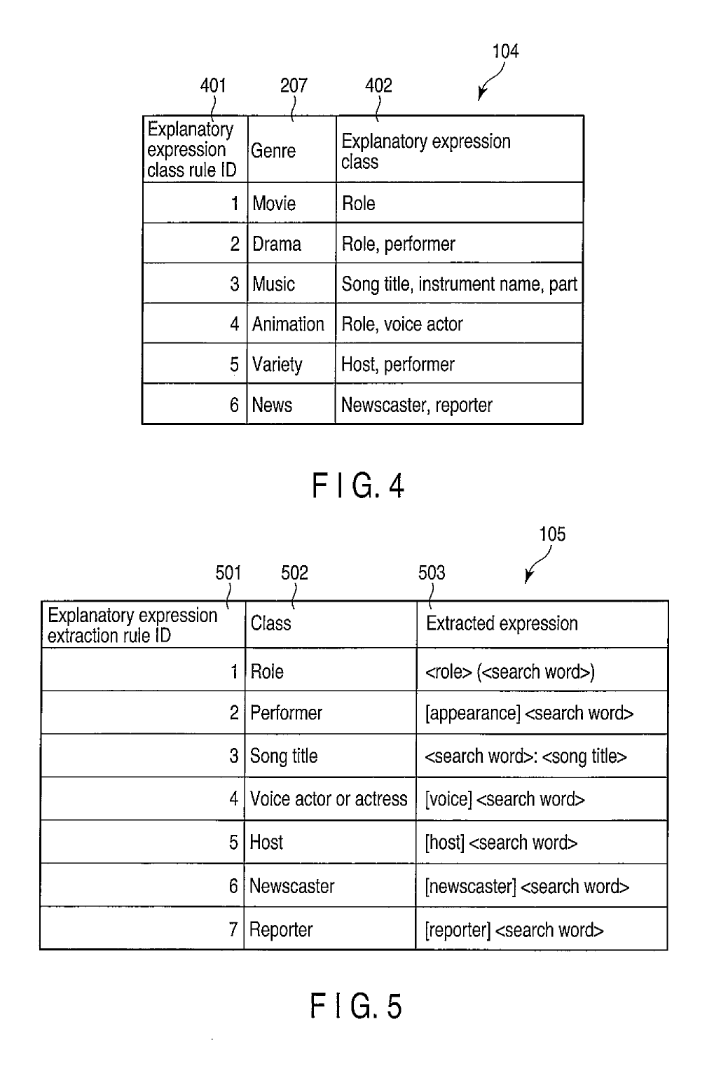

Explanatory expression class determination rules 104 are used to execute explanatory expression class extraction processing in the explanatory expression extraction unit 106 (to be described later). Explanatory expression classes are categories which specify classes to be extracted as explanatory expressions for search words in correspondence with genres of programs. Classes indicate roles or categories of search words in programs, which are extracted in correspondence with genres of the programs. More specifically, the classes include categories such as a role, performer, voice actor, newscaster, song title, animal name, place name, and city name, which are suited to explain search words. The explanatory expression class determination rules 104 will be described later with reference to FIG. 4.

Explanatory expression extraction rules 105 are used to extract character strings required to generate explanatory expressions in the explanatory expression extraction unit 106 (to be described later) as in the explanatory expression class determination rules 104. The explanatory expression extraction rules 105 will be described later with reference to FIG. 5.

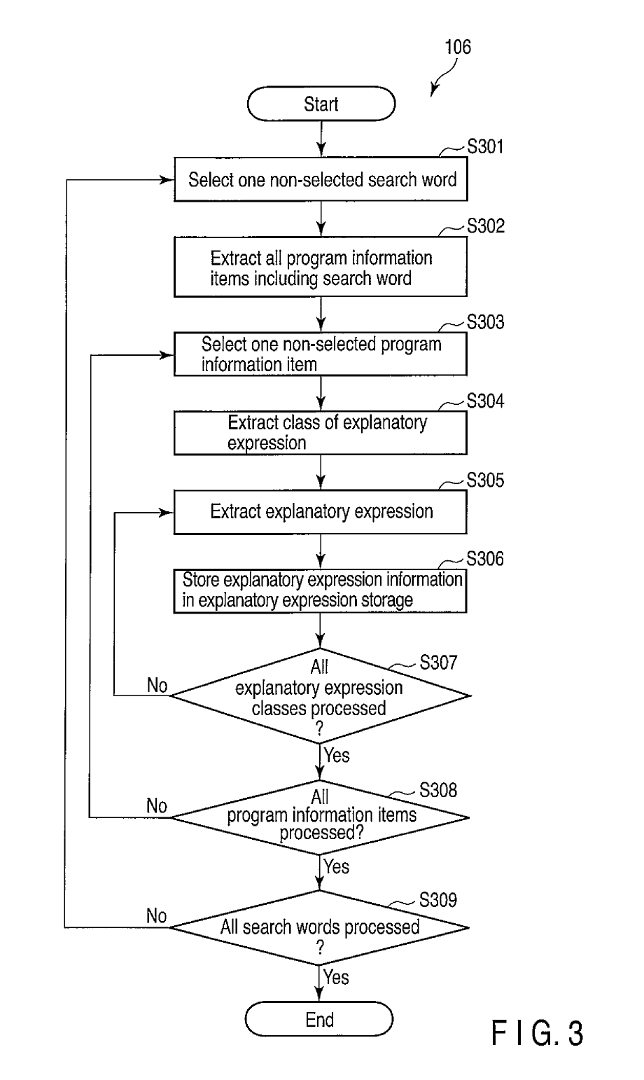

The explanatory expression extraction unit 106 receives the search words from the search word extraction unit 102, executes explanatory expression class extraction processing of the search words with reference to the explanatory expression class determination rules 104 and explanatory expression extraction rules 105, and further executes element (character string) extraction processing required to generate appropriate explanatory expressions for the search words. These two extraction processes will be described later with reference to the flowchart shown in FIG. 3.

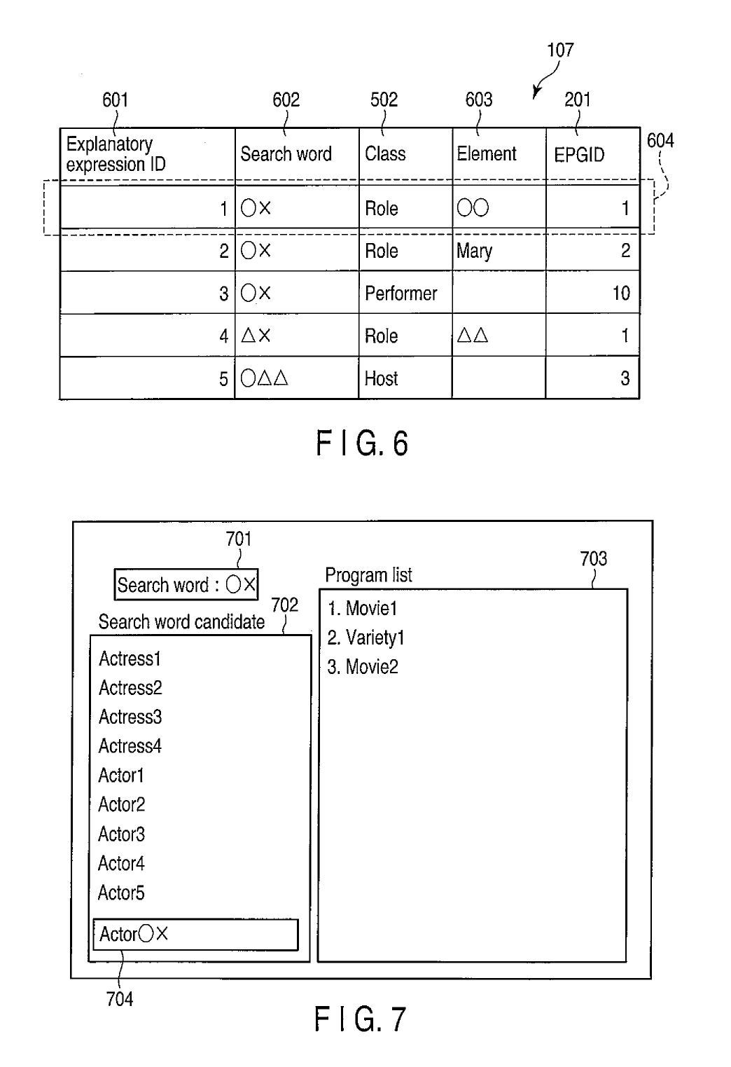

The explanatory expression storage 107 receives the search words and elements corresponding to the search words from the explanatory expression extraction unit 106, and stores them as explanatory expression information item in association with each other. An element is a character string indicating how a person of a search word relates in a program, in other words, a character string which specifies a relationship between a search word and class in a content item. For example, the element indicates a role performed by a person of a search word in a program or a song title sung by a person of a search word in a program. The explanatory expression storage 107 will be described later with reference to FIG. 6.

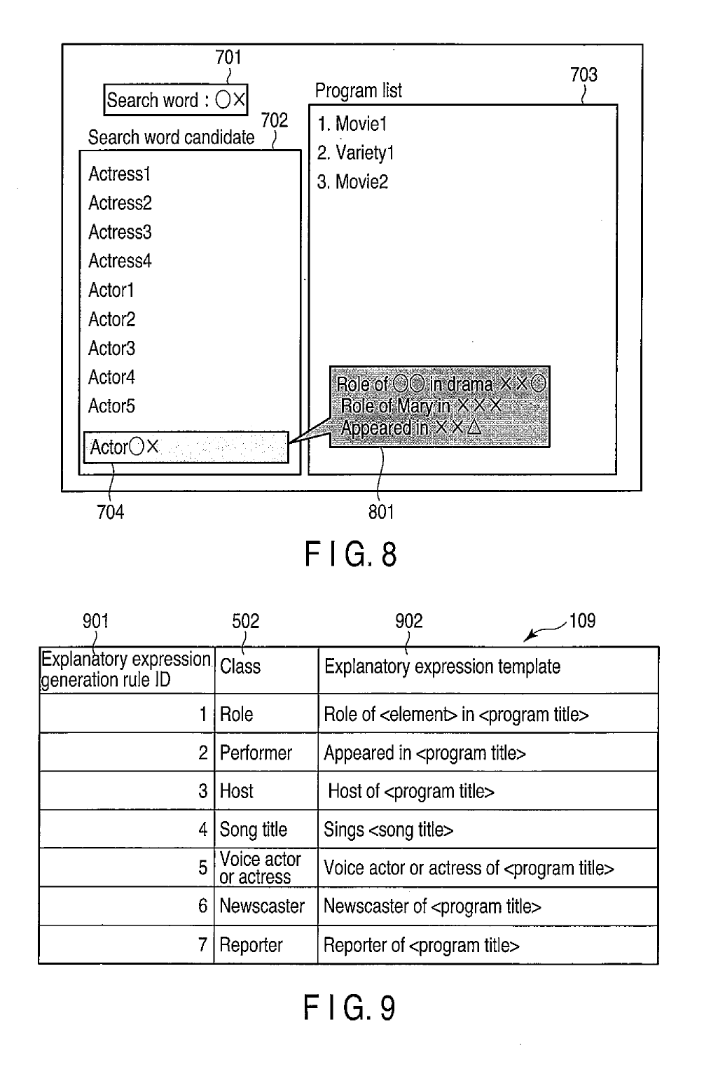

The search word presentation unit 108 extracts search words stored in the search word storage 103, and presents the extracted search words to the user. The search word presentation unit 108 will be described later with reference to FIGS. 7 and 8.

Explanatory expression generation rules 109 are used to generate explanatory expressions to be presented by the explanatory expression presentation unit 110 (to be described later). The explanatory expression generation rules 109 will be described later with reference to FIG. 9.

The explanatory expression presentation unit 110 receives the explanatory expression information items from the explanatory expression storage 107 and search words from the search word presentation unit 108, respectively, generates appropriate explanatory expressions for the search words with reference to the explanatory expression generation rules 109, and presents the explanatory expressions to the user. The explanatory expression presentation unit 110 will be described later with reference to FIGS. 7 and 8.

The operation of the explanatory expression extraction unit 106 will be described in detail below with reference to the flowchart shown in FIG. 3.

In step S301, the explanatory expression extraction unit 106 selects one non-selected search word from the search word storage 103.

In step S302, the explanatory expression extraction unit 106 extracts all program information items including the search word from the program information storage 101 with reference to an EPGID of program information items including the selected search word. Note that if a search word and program information items itself as an extraction source of that search word are stored in the search word storage 103, the explanatory expression extraction unit 106 may select the search word from the search word storage 103, and may also extract the program information items itself as the extraction source of that search word. Furthermore, every time the search word extraction unit 102 extracts a search word, the explanatory expression extraction unit 106 may receive that search word from the search word extraction unit 102, and may receive program information items as an extraction source of that search word from the program information storage 101.

In step S303, the explanatory expression extraction unit 106 selects one non-selected program information item from those extracted in step S302.

In step S304, the explanatory expression extraction unit 106 extracts an explanatory expression class using the explanatory expression class determination rules 104 based on the selected program information item.

An example of the explanatory expression class determination rules 104 will be described in detail below with reference to FIG. 4.

The explanatory expression class determination rules 104 include items of an explanatory expression class rule ID 401, genre 207, and explanatory expression class 402, which are stored in association with each other. Hence, with reference to these rules, a class required to generate an explanatory expression for each genre of a program can be extracted. For example, as can be seen from FIG. 4, if a genre 207 is “drama”, “role, performer” can be extracted as classes required to generate explanatory expressions with reference to an explanatory expression class rule ID=“2” including the same genre 207. Likewise, as can be seen from FIG. 4, if a genre 207 is “music”, “song title, instrument name, part” can be extracted as classes required to generate explanatory expressions with reference to an explanatory expression class rule ID=“3” including the same genre 207.

In step S305, the explanatory expression extraction unit 106 extracts, for the search word selected in step S301, extracted expressions in correspondence with the explanatory expression classes determined in step S304 based on the items of program information items extracted in step S303 and the explanatory expression extraction rules 105. The extracted expression is a character string which is extracted from the substance of program information items and is required to specify a relationship between the search word and class. An element can be extracted from this character string of the extracted expression.

An example of the explanatory expression extraction rules 105 will be described in detail below with reference to FIG. 5.

The explanatory expression extraction rules 105 include items of an explanatory expression extraction rule ID 501, class 502, and extracted expression 503, which are saved in association with each other. Which character string is to be extracted from a substance 208 of a program for a given class can be recognized from these rules. For example, in case of a class 502=“role”, the explanatory expression extraction unit 106 can extract a character string “<role> (<search word>)” from program information items included in EPG data items with reference to a corresponding extracted expression 503. Likewise, in case of a class 502=“song title”, the explanatory expression extraction unit 106 can extract a character string “<search word>: <song title>” from program information items included in EPG data items with reference to a corresponding extracted expression 503. Note that if one person performs a plurality of roles, a plurality of explanatory expression information item 604 may often be extracted for one search word.

In order to extract a part which matches an extracted expression 503 in FIG. 5 from program information items, a role, song title, or the like included in the program information items is required to be identified. In this case, a role can be extracted by matching a personal name in program information items. That is, if program information items includes an expression “<personal name> (<search word>)”, it can be judged that this expression matches an extracted expression of an explanatory expression extraction rule ID 501=“1”. In this case, a word included in program information items has to be identified as a personal name, but such identification can be attained by a state-of-the-art technique. For example, morphological analysis may be applied to program information items to determine, as “role”, a part judged as “name”.

In step S306, the explanatory expression extraction unit 106 generates explanatory expression information items from the extracted expressions 503 extracted in step S305, and stores them in the explanatory expression storage 107. The explanatory expression information items are required to generate an explanatory expression which is extracted from program information items including a search word.

An example of the explanatory expression information items stored in the explanatory expression storage 107 will be described in detail below with reference to FIG. 6.

As shown in FIG. 6, items of an explanatory expression ID 601, search word 602, class 502, element 603, and EPGID 201 are stored as explanatory expression information item 604 in association with each other. For example, as can be seen from explanatory expression information item 604 having an explanatory expression ID 601=“1”, “[role] of a person [Ox] in a search word 602 is [OO], and [Ox] appeared on a program having an EPGID 201=[1]”. Note that by extracting the explanatory expression information item 604 using only program information items of programs viewed and recorded by the user, explanatory expressions which are easy to be understood by the user can be presented. On the other hand, when explanatory expression information item 604 is to be extracted from only program information items of programs viewed and recorded by the user, if these program information items do not include any search word, the explanatory expression information item 604 cannot be extracted. In this case, explanatory expression information item 604 may be extracted from program information items of programs which have not been viewed and recorded by the user.

The explanatory expression extraction unit 106 determines in step S307 whether or not processing is complete for all classes included in the explanatory expression classes 402 of the extracted program information items. If the processing is complete for all the classes, the process advances to step S308; if the processing is not complete for all the classes yet, and classes to be processed included in the explanatory expression classes 402 still remain, the process returns to step S305 to repeat the same processing.

The explanatory expression extraction unit 106 determines in step S308 whether or not processing is complete for all the program information items including the search word. If the processing is complete for all the program information items, the process advances to step S309; if the processing is not complete for all the program information items, and program information items including the search word still remain, the process returns to step S303 to repeat the same processing.

The explanatory expression extraction unit 106 determines in step S309 whether or not the search words included in the search word storage 103 include those to be selected, that is, whether or not processing is complete for all the search words included in the search word storage 103. If the processing is complete for all the search words, the operation of the explanatory expression extraction unit 106 ends; if the processing is not complete for all the search words, and search words to be selected still remain, the process returns to step S301 to repeat the same processing until the processing is complete for all the search words.

A practical example of the operation of the explanatory expression extraction unit 106 shown in FIG. 3 described above will be described below. In this case, only a search word “Ox” will be examined for the sake of simplicity.

Initially, assume that a personal name “Ox” is selected as a search word in step S301.

Subsequently, in step S302, items of program information items having EPGIDs 201=“1” and “2” in FIG. 2 are extracted from EPG data items including the search word “Ox”.

Assume that program information item 209 having the EPGID 201=“1” is selected first in step S303.

In step S304, since a genre 207 of a program having the EPGID 201=“1” is “drama”, an explanatory expression class rule ID 401=“2” corresponding to the genre 207=“drama” is referred to from the explanatory expression class determination rules 104 shown in FIG. 4 to determine explanatory expression classes 402=“role, performer”.

In step S305, based on the explanatory expression classes 402=“role, performer”, in order to acquire information associated with the role, a character string that matches an extracted expression 503=“<role> (<search word>)” of an explanatory expression extraction rule ID=“1” in FIG. 5 is extracted from a substance 208 of the program information item 209 having the EPGID 201=“1” selected in step S303. In this case, “OO (Ox)” is extracted from the substance 208. That is, “OO” is extracted as the role of the search word “Ox”.

In step S306, as an explanatory expression ID 601=“1”, a search word 602=“Ox”, class 502=“role”, element 603=“OO”, and the EPGID 201=“1” are stored as explanatory expression information item 604 in the explanatory expression storage 107 in association with each other.

In step S307, since the processing is complete for the class 502=“role”, but the processing is not executed for a class 502=“performer” yet, the process returns to step S305 to execute extraction processing of a character string which matches the class 502=“performer” of an explanatory expression rule ID=“2”. In this case, since the substance 208 does not include any character string that matches “performer”, information of the performer is not extracted. In this case, since the processing is compete for “role, performer” as all the explanatory expression classes 402, the process advances to step S308.

In step S308, since the processing is complete for the program information item having the EPGID 201=“1”, but since the processing is not executed for the program information item having the EPGID=“2”, the process returns to step S303. Then, in the same sequence from step S304 to step S307, as an explanatory expression ID 601=“2”, the search word 602=“Ox”, the class 502=“role”, an element 603=“Mary”, and the EPGID 201=“2” are stored in the explanatory expression storage 107 in association with each other.

A presentation example of search words by the search word presentation unit 108 and explanatory expression presentation unit 110 after explanatory expression information items 604 are extracted for respective search words, as described above, will be described in detail below with reference to FIGS. 7 and 8.

The example of FIG. 7 includes a selected word box 701, search word candidate box 702, program list box 703, and cursor 704. The search word presentation unit 108 displays a plurality of search words stored in the search word storage 103 in the search word candidate box 702. In this case, the search word presentation unit 108 may display all the search words stored in the search word storage 103 or may extract only the predetermined number of search words, for example, 10 search words from the search word storage 103, and may display them.

Furthermore, in order to select a search word displayed in the search word candidate box 702, when the user moves the cursor 704 to select one search word, the selected search word is displayed in the selected search word box 701, and programs are searched for based on the selected search word, thus displaying search results in the program list box 703. In the practical example of FIG. 7, when the user selects “Ox” as a search word using the cursor 704, programs whose program information items include the search word “Ox” are retrieved, and a list of programs “movie 1”, “variety 1”, and “movie 2” including the search word “Ox” display in the program list box 703.

Next, FIG. 8 shows a screen which displays explanatory expressions of the search word.

The explanatory expression presentation unit 110 extracts explanatory expression information item 604 of the search word focused by the cursor 704 in the search word candidate box 702 from the explanatory expression storage 107, and generates an explanatory expression with reference to the explanatory expression generation rules 109. Then, the explanatory expression presentation unit 110 displays the explanatory expression of the search word focused by the cursor 704 on an explanatory expression display window 801. In this case, only the explanatory expression of the search word focused by the cursor 704 is displayed. Alternatively, all explanatory expressions of search words, which are not focused by the cursor 704, may also be displayed.

An example of the explanatory expression generation rules 109 to be referred to so as to generate an explanatory expression will be described in detail below with reference to FIG. 9.

The explanatory expression generation rules 109 include items of an explanatory expression generation rule ID 901, class 502, and explanatory expression template 902, which are saved in association with each other. For example, a case will be examined below wherein an explanatory expression is generated from an explanatory expression ID 601=“1” for the search word 602=“Ox” included in the explanatory expression information item 604 shown in FIG. 6. As can be seen from FIG. 9, since the class 502 corresponding to the explanatory expression ID 601=“1” is “role”, an explanatory expression can be generated using an explanatory expression generation rule ID=“1” including the same class 502=“role” in FIG. 9. Hence, as the explanatory expression, a program title and an element are respectively extracted from the program information item 209 stored in the program information storage 101 shown in FIG. 2 and the explanatory expression information item 604 stored in the explanatory expression storage 107 shown in FIG. 6, and are applied to text “appeared on <program title> as <element>” of the explanatory expression template 902 corresponding to the explanatory expression generation rule ID=“1”.

A practical extraction method of <program title> and <element> will be described below. With reference to an EPGID 201 included in explanatory expression information item 604, since the EPGID 201 is “1”, the corresponding EPGID 201=“1” is referred to from EPG data items stored in the program information storage 101. Since a program title 206 corresponding to the EPGID 201=“1” is “drama xxO”, “drama xxO” is extracted as <program title>. Furthermore, with reference to an element 603 corresponding to the EPGID 201=“1” included in the explanatory expression 604, it is detected that <element> is “OO”. Hence, they are applied to the explanatory expression template 902 to generate an explanatory expression “role of OO in drama xxO”.

In the example of FIG. 8, three explanatory expressions “role of OO in drama xxO”, “Mary of xxx”, and “appeared on xxΔ” are displayed on the explanatory expression display window 801 as those of the search word “Ox”. When there are a plurality of explanatory expression information item 604 for one search word, a plurality of explanatory expressions as many as the number of explanatory expression information item 604 stored in the explanatory expression storage 107 may be displayed as in this example, or explanatory expression information items 604 may be selectively displayed in descending order of priority. As descending order of priority, explanatory expression information item 604 with the highest priority is that which is extracted from EPG data items of programs which have been viewed or recorded by the user with reference to the viewing/recording history information 111 of the user, when EPG data items of all broadcast programs are stored in the program information storage 101. Explanatory expression information item 604 with the second highest priority is that corresponding to a latest broadcast date 203 of program information items 209.

When an explanatory expression is generated from explanatory expression 604 with high priority, as described above, since the explanatory expression information items are generated from program information items of programs which have been viewed and recorded, the user can easily recognize a forgotten search word. Also, when an explanatory expression is generated from program information items of a program, which was broadcast recently, since a remembering probability of the user is high, the user can recognize a search word more easily. When an explanatory expression is generated from important explanatory expression information items, different explanatory expressions can be displayed for respective users even when a search word remains the same. For example, assume that a search word “Ox” appeared in program A in the role of OO, and in program B in the role of xx. When user A has a viewing history of only program A, and user B has a viewing history of only program B, the system can display “role of OO in program A” as an explanatory expression of “Ox” on the screen operated by user A, and can display “role of xx in program B” on the screen operated by user B, thus allowing to display different explanatory expressions for respective users.

According to the aforementioned embodiment, the user remembers an actor as a role in place of the actor name in a drama or variety, and it is often difficult for the user to recognize a person even when the actor name or performer name is displayed. Even in such case, when the user selects presented search words, a role and a program on which that person appeared on the past are displayed as explanatory expressions associated with each search word, thus allowing the user to recognize that search word. Furthermore, priority is assigned based on the viewing and recording histories of programs, and broadcast dates of the programs, and explanatory expressions are generated in turn from program information items with higher priority and are presented to the user. Hence, optimal explanatory expressions can be presented for each user.

In this embodiment, a personal name has been exemplified as a search word. The same processing applies to a case in which keywords other than personal names are handled as search words. For example, keywords include place names (New York, Seattle, etc.), and by applying this embodiment to a place name having a low recognition degree and about which no one knew, the user can easily recognize that keyword.

The flow charts of the embodiments illustrate methods and systems according to the embodiments. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A content item search apparatus, comprising:
an extraction unit configured to extract at least one of elements from at least one of content items for each of classes, based on extraction rules indicating expressions used to extract the elements which indicate character strings required to specify relationships between a search word and the classes in the content items, the elements corresponding to the search word in association with each other, the classes each indicating either one of a role and a category, the role and the category being those of the search word in each of the content items;
a first storage to store expression information items, the expression information items each comprising one of the extracted elements and the search word, the search word being stored for each class; and
a presentation unit configured to generate one or more explanatory expressions associated with the search word based on generation rules and the expression information items and present the one or more explanatory expression for each search word, the generation rules each indicating a template used to generate the explanatory expressions which indicate explanatory texts of the search word.

2. The apparatus according to claim 1, further comprising:
a second storage to store the content items, history information items indicating whether or not a user has viewed or recorded the content items, and date and time information items of the content items in association with each other,
wherein if a first history information item indicates that the user has viewed or recorded any one of the content items, the presentation unit presents a first explanatory expression generated using the any one, and if the first history information indicates that the user has not viewed or recorded all of the content items, the presentation unit presents a second explanatory expression generated using a content item having a latest date and time information item, the content item being included in the content items.

3. The apparatus according to claim 2, wherein the presentation unit selectively presents at least one of the first explanatory expression and the second explanatory expression for each user in accordance with whether or not the history information items for each user exist.

4. The apparatus according to claim 1, wherein the presentation unit presents the explanatory expressions and the search word corresponding to the explanatory expressions together.

5. The apparatus according to claim 1, wherein the extraction unit extracts the classes based on determination rules indicating categories of the classes required to generate the explanatory expressions in accordance with a genre of each of the content items.

6. The apparatus according to claim 1, wherein the search word is a personal name, and the elements include at least one of a role performed by a person corresponding to the search word in the content items, and a song title sung by a person corresponding to the search word in the content items.

7. A content item search method, comprising:
extracting at least one of elements from at least one of content items for each of classes, based on extraction rules indicating expressions used to extract the elements which indicate character strings required to specify relationships between a search word and the classes in the content items, the elements corresponding to the search word in association with each other, the classes each indicating either one of a role and a category, the role and the category being those of the search word in each of the content items;
storing in a first storage expression information items, the expression information items each comprising one of the extracted elements and the search word, the search word being stored for each class;
generating one or more explanatory expressions associated with the search word based on generation rules and the expression information items, the generation rules each indicating a template used to generate the explanatory expressions which indicate explanatory texts of the search word; and
presenting the one or more explanatory expression for each search word.

8. The method according to claim 7, further comprising:
storing in a second storage the content items, history information items indicating whether or not a user has viewed or recorded the content items, and date and time information items of the content items in association with each other,
wherein if a first history information item indicates that the user has viewed or recorded any one of the content items, the presenting the explanatory expressions presents a first explanatory expression generated using the any one, and if the first history information indicates that the user has not viewed or recorded all of the content items, the presenting the explanatory expressions presents a second explanatory expression generated using a content item having a latest date and time information item, the content item being included in the content items.

9. The method according to claim 8, wherein the presenting the explanatory expressions selectively presents at least one of the first explanatory expression and the second explanatory expression for each user in accordance with whether or not the history information items for each user exist.

10. The method according to claim 7, wherein the presenting the explanatory expressions presents the explanatory expressions and the search word corresponding to the explanatory expressions together.

11. The method according to claim 7, wherein the extracting the elements extracts the classes based on determination rules indicating categories of the classes required to generate the explanatory expressions in accordance with a genre of each of the content items.

12. The method according to claim 7, wherein the search word is a personal name, and the elements include at least one of a role performed by a person corresponding to the search word in the content items, and a song title sung by a person corresponding to the search word in the content items.

13. A non-transitory computer readable medium including computer executable instructions, wherein the instructions, when executed by a processor, cause the processor to perform a method comprising:
extracting at least one of elements from at least one of content items for each of classes, based on extraction rules indicating expressions used to extract the elements which indicate character strings required to specify relationships between a search word and the classes in the content items, the elements corresponding to the search word in association with each other, the classes each indicating either one of a role and a category, the role and the category being those of the search word in each of the content items;
storing in a first storage expression information items, the expression information items each comprising one of the extracted elements and the search word, the search word being stored for each class;
generating one or more explanatory expressions associated with the search word based on generation rules and the expression information items, the generation rules each indicating a template used to generate the explanatory expressions which indicate explanatory texts of the search word; and
presenting the one or more explanatory expression for each search word.

14. The computer readable medium according to claim 13, further comprising:
storing in a second storage the content items, history information items indicating whether or not a user has viewed or recorded the content items, and date and time information items of the content items in association with each other,
wherein if a first history information item indicates that the user has viewed or recorded any one of the content items, the presenting the explanatory expressions presents a first explanatory expression generated using the any one, and if the first history information indicates that the user has not viewed or recorded all of the content items, the presenting the explanatory expressions presents a second explanatory expression generated using a content item having a latest date and time information item, the content item being included in the content items.

15. The computer readable medium according to claim 14, wherein the presenting the explanatory expressions selectively presents at least one of the first explanatory expression and the second explanatory expression for each user in accordance with whether or not the history information items for each user exist.

16. The computer readable medium according to claim 13, wherein the presenting the explanatory expressions presents the explanatory expressions and the search word corresponding to the explanatory expressions together.

17. The computer readable medium according to claim 13, wherein the extracting the elements extracts the classes based on determination rules indicating categories of the classes required to generate the explanatory expressions in accordance with a genre of each of the content items.

18. The computer readable medium according to claim 13, wherein the search word is a personal name, and the elements include at least one of a role performed by a person corresponding to the search word in the content items, and a song title sung by a person corresponding to the search word in the content items.
